(19) United States
(12) Patent Application Publication
(10) Pub. No.: US 2008/0074555 A1
(43) Pub. Date: Mar. 27, 2008

(54) RESET CIRCUIT AND METHOD FOR HIGH DEFINITION MULTIMEDIA INTERFACE

(75) Inventors: Wen-Chen Chen, Taipei (TW); Lien-Fu Hu, Taipei (TW)

Correspondence Address: J C PATENTS, INC., 4 VENTURE, SUITE 250, IRVINE, CA, 92618, US

(73) Assignee: OPTOMA CORPORATION, Taipei (TW)

(21) Appl. No.: 11/777,754

(22) Filed: Jul. 13, 2007

(30) Foreign Application Priority Data
Sep. 26, 2006 (TW) 95135529

(51) Int. Cl. H04N 9/64

(52) U.S. Cl. 348/720; 348/E09.037

(57) ABSTRACT

A reset circuit and a reset method for a high definition multimedia interface (HDMI) are provided. The reset circuit includes a first resistor, a second resistor, and a regulation unit. When a host system changes resolution of multimedia data, the regulation unit regulates a hot-plug detect signal to generate a logic low level pulse signal, so as to reset the data connection between the host system and a display apparatus. Thus, the multimedia data are displayed normally without resetting a connector.

### CROSS-REFERENCE TO RELATED APPLICATION

This application claims the priority benefit of Taiwan application serial no. 95135529, filed on Sep. 26, 2006. All disclosure of the Taiwan application is incorporated herein by reference.

### BACKGROUND OF THE INVENTION

1. Field of the Invention

The present invention relates to a reset circuit that enhances the stability of high-bandwidth digital content protection (HDCP) encoding and decoding when changing resolution. More particularly, the present invention relates to a reset circuit and a reset method for a high definition multimedia interface (HDMI).

2. Description of Related Art

As consumers are in pursuit of higher image quality, High Definition Multimedia Interfaces (HDMI interface) has become a mainstream interface in consumer electronic products. The HDMI interface is developed on the basis of Digital Visual Interface (DVI interface) capable of simultaneously transmitting visual and audio signals. In terms of the application in digital electronic products, the HDMI interface is more convenient and smaller compared with the DVI interface, so it is expected to be an important interface for future digital electronic products.

HDCP is primarily an encoding and decoding method for multimedia data. Currently, the electronic products on the market are starting to support the HDMI interface and HDCP. When multimedia data are transmitted between an HDMI source with an HDMI interface and HDCP (e.g., a computer or a video player, hereinafter referred to as a host system) and an HDMI sink (e.g., a television, an LCD display, a PDP television, or a CRT display, hereinafter referred to as a display apparatus), the HDCP establishes the HDCP between the host system and the display apparatus, so as to transmit and display the multimedia data normally.

When the host system changes the resolution of the multimedia data or changes the resolution of the display apparatus, the reestablishment and encoding/decoding of the HDCP become unstable, such that the display apparatus cannot display the multimedia data normally. The host system uses a hot-plug detect signal (e.g., the hot-plug detect signal transmitted by Pin 19 for an A-Type HDMI connector) of the HDMI interface to identify the coupling state between the display device and the host system. When the hot-plug detect signal is a logic high level pulse signal, the host system and the display apparatus are in a coupled state. When the hot-plug detect signal is a logic low level pulse signal, the host system reads Extended Display Identification Data (EDID) again to reestablish the HDCP. Therefore, in the conventional art, in order to solve the problem that the display apparatus does not function normally, it is required to disconnect and connect the HDMI connector again or restart the host system to enable the host system to read the EDID again and reestablish the HDCP.

### SUMMARY OF THE INVENTION

The present invention is directed to a reset circuit for a high definition multimedia interface, which regulates a hot-plug detect signal of an HDMI interface to generate a logic low voltage pulse signal when a host system changes resolution of multimedia data, so as to reset a data connection between the host system and a display apparatus. Thus, the multimedia data are displayed normally without resetting a connector.

The present invention is also directed to a reset method for a high definition multimedia interface, which resets the hot-plug detect signal of the HDMI interface to reset the data connection between the host system and the display apparatus when the host system changes the resolution of the multimedia data.

To achieve the aforementioned and other aspects, the present invention provides a reset circuit for a high definition multimedia interface which is capable of resetting the data connection between the host system and the display apparatus, such that the host system outputs the multimedia data to the display apparatus. The reset circuit includes a first resistor, a second resistor, and a regulation unit. The first resistor is coupled to a hot-plug detection pin of the high definition multimedia interface, and the second resistor is coupled between the other terminal of the first resistor and a ground terminal. The host system receives a hot-plug detect signal via a common node of the first resistor and the second resistor, and determines a data connection state between the host system and the display apparatus according to the hot-plug detect signal. The regulation unit is coupled to the common node of the first resistor and the second resistor. When the host system changes the resolution of the multimedia data, the regulation unit regulates the hot-plug detect signal to reset the data connection between the host system and the display apparatus.

To achieve the aforementioned and other aspects, the present invention provides a reset method for a high definition multimedia interface which is capable of resetting a data connection between a host system and a display apparatus. The host system outputs the multimedia data to the display apparatus, and determines a data connection state between the host system and the display apparatus according to a hot-plug detect signal. The reset method includes firstly, determining whether or not the host system changes the resolution of the multimedia data; if yes, a control signal is enabled and the hot-plug detect signal is regulated to generate a pulse signal according to the control signal, so as to reset the data connection between the host system and the display apparatus.

When the host system changes the resolution of the multimedia data, the present invention uses a regulation unit to regulate the hot-plug detect signal of a HDMI interface to generate a logic low level pulse signal, so as to reset a HDCP between the host system and the display apparatus. When the resolution of the multimedia data is changed, the multimedia data are displayed normally without resetting the connector. Thus, the stability and convenience in use of the HDMI interface is improved.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of a HDMI transmission architecture according to an embodiment of the present invention.

FIG. 2 shows a waveform of the hot-plug detect signal according to this embodiment.

FIG. 3 is a circuit diagram of the reset circuit according to another embodiment of the present invention.

FIG. 4 is a circuit diagram of the reset circuit according to another embodiment of the present invention.

FIG. 5 is a circuit diagram of the reset circuit according to another embodiment of the present invention.

FIG. 6 is a circuit diagram of the reset circuit according to another embodiment of the present invention.

FIG. 7 is a flow chart of the reset method for a high definition multimedia interface according to another embodiment of the present invention.

### DESCRIPTION OF EMBODIMENTS

It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

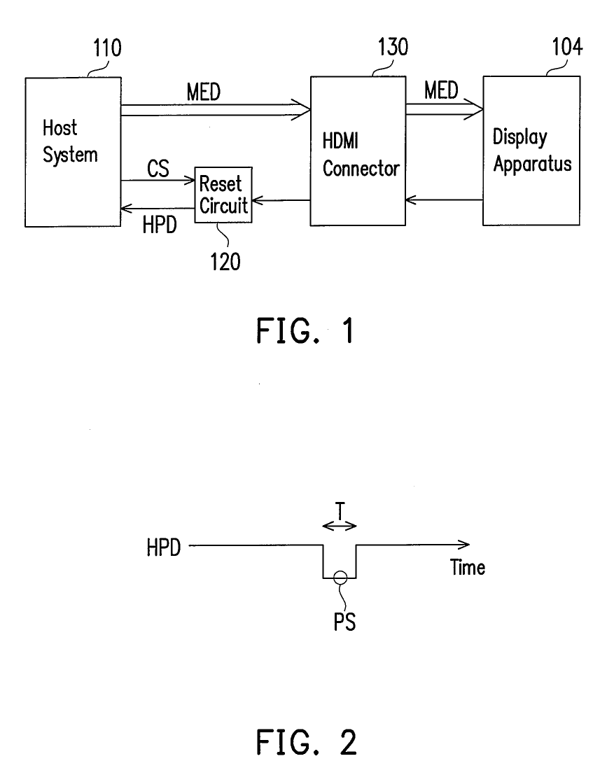

FIG. 1 is a block diagram of a high definition multimedia interface (HDMI) transmission architecture according to an embodiment of the present invention. The HDMI transmission architecture 100 includes a host system 110, a reset circuit 120, a high definition multimedia interface connector (HDMI connector) 130, and a display apparatus 140. The display apparatus 140 is coupled to the host system 110 via the HDMI connector 130. The reset circuit 120 is coupled between the host system 110 and the HDMI connector 130.

The HDMI connector 130 has a plurality of pins with different functions. The host system 110 receives a hot-plug detect signal HPD via a hot-plug detect pin (e.g., Pin 19 for a A-Type or C-Type HDMI connector, or Pin 29 for a B-Type HDMI connector). The host system 110 outputs multimedia data MED to the display apparatus 140 via other pins of the HDMI connector 130. When the resolution of the multimedia data MED or the display apparatus 140 changes, the host system 110 outputs a control signal CS to the reset circuit 120 to regulate the hot-plug detect signal HPD, and resets the data connection (e.g., the HDCP) between the host system 110 and the display apparatus 140.

As for the HDMI interface, when the hot-plug detect signal HPD generates a logic low level pulse signal and the period of the signal is greater than or equal to 100 ms, the host system 110 resets the data connection between the host system 110 and the display apparatus 140. That is, the host system 110 reconfirms the physical address of the display apparatus 140 and reads EDID data in the display apparatus 140 again, and reestablishes the HDCP. Therefore, in this embodiment, when the host system 110 changes the resolution of the multimedia data MED, the control signal CS is enabled. The reset circuit 120 regulates the hot-plug detect signal HPD to generate a logic low level pulse signal with a width greater than or equal to 100 ms according to the enabling period of the control signal CS.

FIG. 2 shows a waveform of the hot-plug detect signal according to this embodiment. In the normal state, i.e., the state that the host system 110 and the display apparatus 140 are normally coupled, the hot-plug detect signal HDP is at logic high level. When the host system 110 changes the resolution of the multimedia data MED, the hot-plug detect signal HPD is regulated to generate a logic low level pulse signal PS with a pulse width T greater than or equal to 100 ms.

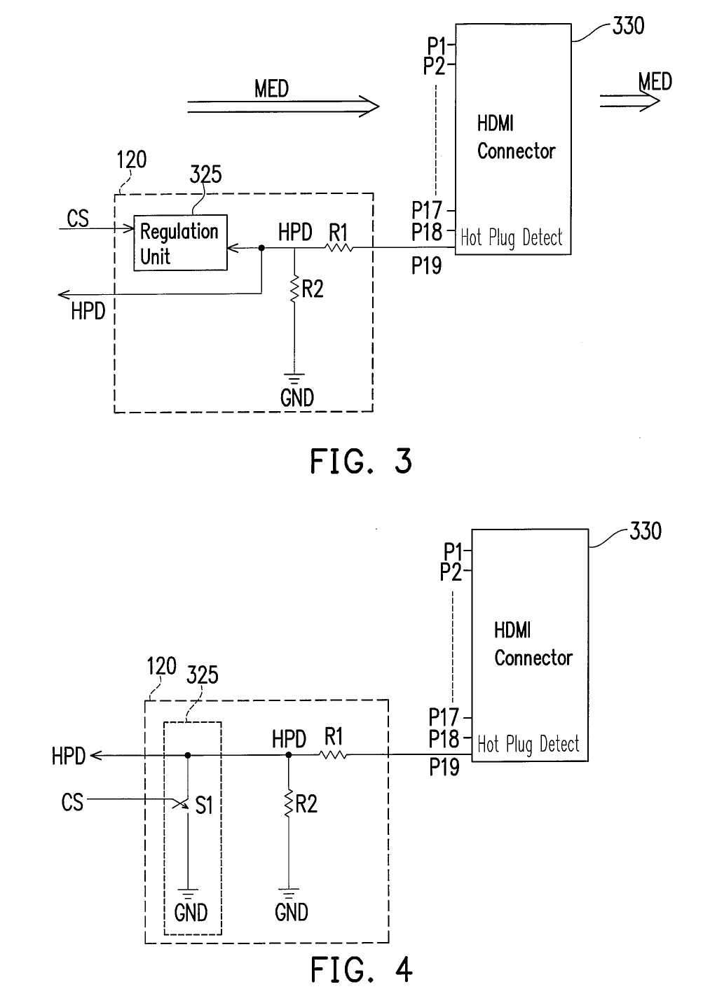

Hereinafter, the circuit layout of the reset circuit 120 is further illustrated. Referring to FIGS. 3 and 1 together, FIG. 3 is a circuit diagram of the reset circuit according to another embodiment of the present invention. The reset circuit 120 is coupled between the detect pin P19 (the hot-plug detect pin for the A-Type HDMI connector) of the HDMI connector 330 and the host system. The reset circuit 120, the HDMI connector 330, and the host system are integrated into the same system, for example, a host computer having an HDMI connector.

The reset circuit 120 includes a first resistor R1 (resistor R1), a second resistor R2 (resistor R2), and a regulation unit 325. The resistor R1 is coupled between the pin P19 and the resistor R2, and the other terminal of the resistor R2 is coupled to the ground terminal GND. The regulation unit 325 is coupled to the common node of the resistor R1 and the resistor R2, and the common node of the resistor R1 and the resistor R2 outputs the hot-plug detect signal HPD. The host system 110 determines the data connection state between the host system 110 and the display apparatus 140 according to the hot-plug detect signal HPD. In this embodiment, if the host system 110 and the display apparatus 140 are in the normal working state, the hot-plug detect signal HPD is at logic high level. If the host system 110 and the display apparatus 140 are in the disconnected state, the hot-plug detect signal HPD is at logic low level. According to the specification of the HDMI interface, when the hot-plug detect signal HPD generates the logic low level pulse signal with the pulse width greater than or equal to 100 ms, the host system 110 and the display apparatus 140 reestablish the HDCP, i.e., reestablish the data connection between the host system 110 and the display apparatus 140.

Therefore, in this embodiment, when the host system 110 changes the resolution of the multimedia data MED, the control signal CS is output to the regulation signal 325 simultaneously. The regulation unit 325 regulates the hot-plug detect signal HPD according to the control signal CS, so as to reestablish the data connection between the host system 110 and the display apparatus 140. In other words, the regulation unit 325 regulates the hot-plug detect signal HPD to generate the pulse signal with the pulse width greater than or equal to 100 ms. Upon detecting the change of the hot-plug detect signal HPD, the host system 110 reestablishes the HDCP, such that the display apparatus 140 displays the multimedia data MED normally.

Hereinafter, the circuit layout of the regulation unit is further illustrated. Referring to FIG. 4, a circuit diagram of the reset circuit according to another embodiment of the present invention is shown. In the embodiment of FIG. 4, a switching element S1 is taken as the example to illustrate the implementation method of the regulation unit 325. The regulation unit 325 includes the switching element S1 coupled between the common node of the resistors R1, R2 and the ground terminal GND. When the resolution of the multimedia data MED changes, the host system 110 enables the control signal CS, which can be at logic high level or logic low level according to the design of the switching element S1, and the switching element S1 is turned on during the enabling period of the control signal CS. Therefore, the hot-plug detect signal HPD generates a logic low level pulse signal. The pulse width of the pulse signal is controlled by the interval of the enable time of the control signal CS. In this embodiment, the enabling time of the control signal CS is greater than or equal to 100 ms.

The control signal CS is generated by the host system 110, according to the change of the resolution of the multimedia data MED, or is output by a microprocessor according to the change of the resolution of the multimedia data MED. Persons of ordinary skill in the art can easily derive the generation methods of the control signal CS by referring to the disclosure of the present invention and therefore the detail description thereof will not be illustrated herein.

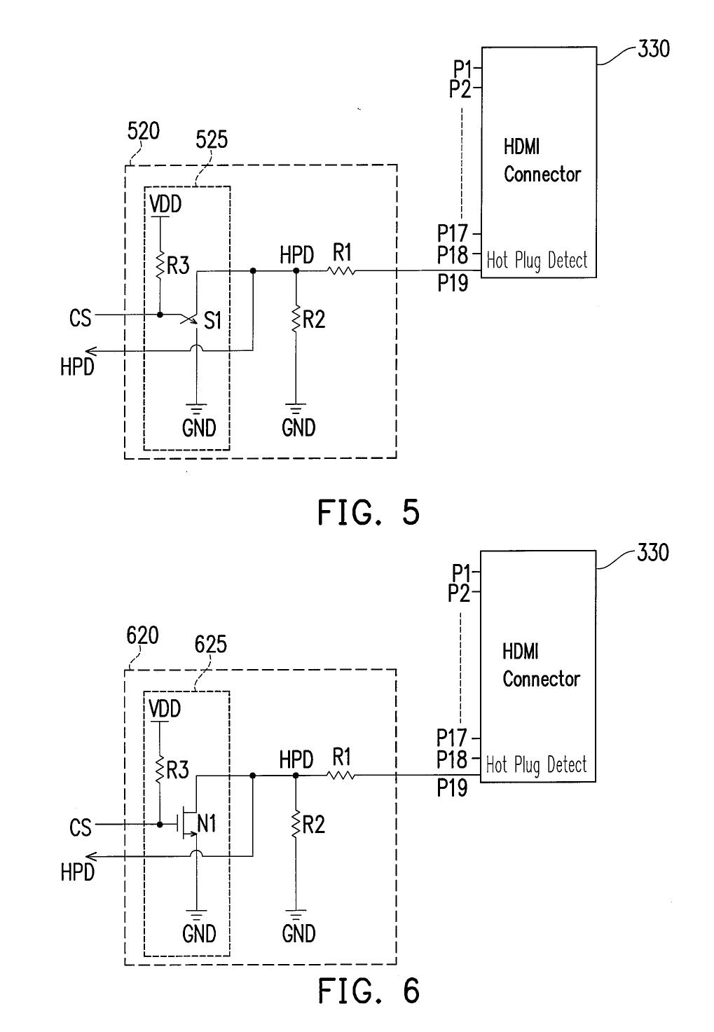

FIG. 5 is a circuit diagram of the reset circuit of another embodiment of the present invention. FIG. 5 is different from FIG. 4 mainly in terms of the regulation unit 525. The regulation unit 525 includes a third resistor R3 (hereinafter referred to as resistor R3) and the switching element S1. The resistor R3 is coupled between a working voltage VDD and a control terminal of the switching element S1. When the control signal CS is not enabled, the resistor R3 makes the control terminal of the switching element S1 in the state of logic high level, and keeps the switching element S1 in the OFF state. In this embodiment, when the control signal CS is at the logic low level (when the control signal CS is enabled), the switching element S1 is turned on. When the control signal CS is converted from the logic low level to the logic high level, the switching element S1 is turned off. As the resistor R3 exists, the speed of turning off the switching element S1 is accelerated, i.e., the converting time of the control signal CS is reduced. Moreover, when the control signal CS does not function normally, the switching element S1 is in the OFF state, so as to avoid influencing the normal operation of the HDMI interface.

In another embodiment of the present invention, the switching element S1 is replaced by another element having the switching function, e.g., an N-type MOSFET transistor (NMOS transistor), a P-type MOSFET transistor (PMOS transistor), or a relay. Different switching elements are applicable as long as the voltage level of the control signal CS when enabled is properly regulated. Referring to FIG. 6, a circuit diagram of the reset circuit according to another embodiment of the present invention is shown, in which the NMOS transistor is taken as the example. FIG. 6 is different from FIG. 5 mainly in terms of the regulation unit 625 in the reset circuit 620. The switching element in the regulation unit 625 is replaced by the NMOS transistor N1. Therefore, in the embodiment of FIG. 6, the control signal CS when enabled is at the logic high level, and the control signal CS when not enabled is at the logic low level. Other operations of the embodiment of FIG. 6 are similar to the description of FIGS. 1-5, and therefore will not be repeated hereinafter.

The implementation method of the regulation unit is not limited to the above description, and any implementation method is applicable as long as it is capable of regulating the hot-plug detect signal HPD according to the change of the multimedia data MED to reset the data connection between the host system and the display apparatus. Persons of ordinary skill in the art can easily derive other applicable implementation methods by referring the disclosure of the present invention, and the details of the implementation methods will not be illustrated herein. In addition, the specification of the HDMI interface must be taken into consideration in the configuration of the resistors R1, R2, for example, the resistor R1 is 1K Ω, and the resistor R2 is 20K Ω. Persons of ordinary skill in the art can easily derive other applicable resistance from the disclosure of the present invention, and the details will not be illustrated herein again.

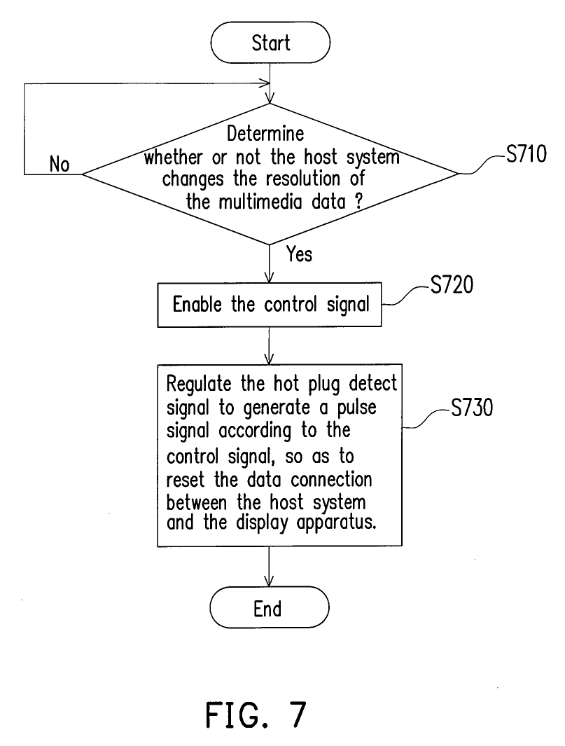

According to another embodiment of the present invention, a reset method for a high definition multimedia interface (HDMI) is provided. FIG. 7 is a flow chart of the reset method for a high definition multimedia interface according to another embodiment of the present invention. The reset method is suitable for resetting the data connection between the host system and the display apparatus. The host system outputs a multimedia data to the display apparatus, and the host system determines the data connection state between the host system and the display apparatus according to a hot-plug detect signal. The reset method includes the following steps.

First, in Step S710, whether or not the host system changes the resolution of the multimedia data is determined, if yes, the flow enters Step S720. In Step S720, if the host system changes the resolution of the multimedia data, a control signal is enabled. Thereafter, the flow enters Step S730 where the hot-plug detect signal is regulated to generate a pulse signal according to the control signal, so as to reset the data connection between the host system and the display apparatus.

In another embodiment of the present invention, the pulse width of the pulse signal is greater than or equal to 100 ms. Other details of the embodiment of FIG. 7 have been described in the embodiments of FIGS. 1-6 in detail, and therefore will not be repeated hereinafter.

When the host system or the display apparatus changes the resolution, the present invention resets the data connection (e.g., the HDCP) between the host system and the display apparatus through the regulation of the hot-plug detect signal without resetting the HDMI connector. Thus, the possibility of the display errors caused by misjudgment of the display apparatus may be effectively prevented, and the stability of the HDMI interface and the HDCP in use may be effectively improved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A reset circuit for a high definition multimedia interface capable of resetting a data connection between a host system and a display apparatus, the host system outputting a multimedia data to the display apparatus, the reset circuit comprising:
a first resistor, coupled to a hot-plug detect pin of the high definition multimedia interface;
a second resistor, coupled between the other terminal of the first resistor and a ground terminal, wherein the host system receives a hot-plug detect signal via a common node of the first resistor and the second resistor, and determines a data connection state between the host system and the display apparatus according to the hot-plug detect signal; and
a regulation unit, coupled to the common node of the first resistor and the second resistor;
wherein the regulation unit regulates the hot-plug detect signal to reset the data connection between the host system and the display apparatus when the host system changes resolution of the multimedia data.

2. The reset circuit as claimed in claim 1, wherein the regulation unit comprises a switching element, one terminal of the switching element coupled to the common node of the first resistor and the second resistor and the other terminal of the switching element coupled to the ground terminal, and
the regulation unit turns on the switching element during an enabling period of a control signal and regulates the hot-plug detect signal to generate a pulse signal when the host system changes the resolution of the multimedia data.

3. The reset circuit as claimed in claim 2, further comprising a microprocessor for outputting the control signal, and wherein the microprocessor enables the control signal to form the pulse signal when the host system changes the resolution of the multimedia data.

4. The reset circuit as claimed in claim 2, wherein the host system outputs the control signal, and the host system enables the control signal to form the pulse signal when the host system changes the resolution of the multimedia data.

5. The reset circuit as claimed in claim 2, wherein the pulse signal is at a logic low level, and a pulse width of the pulse signal is greater than or equal to 100 ms.

6. The reset circuit as claimed in claim 2, wherein the switching element comprises a P-type MOSFET transistor, an N-type MOSFET transistor or a relay.

7. The reset circuit as claimed in claim 2, wherein the regulation unit comprises a third resistor coupled between a working voltage and a control terminal of the switching element.

8. The reset circuit as claimed in claim 7, wherein a resistance of the first resistor is 1K Ω, a resistance of the second resistor is 20 k Ω, and a resistance of the third resistor is 10 k Ω.

9. The reset circuit as claimed in claim 1, wherein the host system comprises a computer or a video player.

10. The reset circuit as claimed in claim 1, wherein the display apparatus comprises a Liquid Crystal Display display, a Plasma Display Panel television or a Cathode Ray Tube display.

11. A reset method for a high definition multimedia interface capable of resetting a data connection between a host system and a display apparatus, the host system outputting a multimedia data to the display apparatus, and the host system determining a data connection state between the host system and the display apparatus according to a hot-plug detect signal, the reset method comprising:
determining whether or not the host system changes resolution of the multimedia data;
enabling a control signal when the host system changes the resolution of the multimedia data; and
regulating the hot-plug detect signal to generate a pulse signal according to the control signal to reset the data connection between the host system and the display apparatus.

12. The reset method as claimed in claim 11, wherein a pulse width of the pulse signal is greater than or equal to 100 ms.
